(19) United States
(12) Patent Application Publication
(10) Pub. No.: US 2011/0311126 A1
(43) Pub. Date: Dec. 22, 2011

(54) DEFECT INSPECTING APPARATUS AND DEFECT INSPECTING METHOD

(76) Inventors: Kaoru Sakai, Yokohama (JP); Shunji Maeda, Yokohama (JP)

(21) Appl. No.: 13/146,033

(22) PCT Filed: Dec. 10, 2009
(86) PCT No.: PCT/JP2009/006767

§ 371 Date: Sep. 7, 2011

(30) Foreign Application Priority Data
Jan. 27, 2009 (JP) 2009-015282

(51) Int. Cl. G06K 9/00

(52) U.S. Cl. 382/149

(57) ABSTRACT

A defect inspecting apparatus provide with an illumination optical system and a detection optical system is further provided with an image processing section, which has: a feature calculating section, which calculates a feature based on the inputted design data of the object to be inspected, and calculates a feature quantity based on a plurality of pieces of image data, which are acquired by the detection optical system and have different optical conditions or image data acquisition conditions; a defect candidate detecting section which integrates the feature obtained from the calculated design data and the feature quantity obtained from the plurality of pieces of image data and detects candidates; and a defect extracting section which extracts a highly critical defect from the detected defect candidates, based on the feature of the design data calculated by the feature calculating section.

### TECHNICAL FIELD

The present invention relates to inspection to compare an inspection object image (detected image) obtained by using light or laser or an electron beam with a reference image and detect a fine pattern defect, extraneous material and the like based on the result of comparison, and more particularly, to a defect inspecting apparatus and a method in the apparatus appropriate to perform visual examination on a semiconductor wafer, a TFT, a photo mask and the like.

### BACKGROUND ART

As a conventional technique of defect detection by comparing a detected image with a reference image, a method disclosed in Japanese Published Unexamined Patent Application No. Hei 05-264467 (Patent Reference 1) is known. In this method, image pickup is sequentially performed on a an object to be inspected where a repetitive pattern is regularly arrayed with a line sensor, then comparison is made with an image time-delayed for the pitch of the repetitive pattern, and a mismatch part is detected as a defect.

### CITATION LIST

### Patent Reference

Patent Reference 1: Japanese Published Unexamined Patent Application No. Hei 05-264467

### SUMMARY OF THE INVENTION

### Technical Problem

In a semiconductor wafer as an object to be inspected, even between adjacent chips, a slight film thickness difference occurs in patterns due to flattening by CMP or the like, and local brightness difference (luminance difference) occurs in images between the chips. When a part where the luminance difference is equal to or higher than a predetermined threshold value th is determined as a defect as in the case of the conventional method, such area where a brightness difference occurs due to the film thickness difference is also detected as a defect. This should not be detected as a defect, i.e., such detection is a false alarm. Conventionally, as one method to avoid the occurrence of false alarm, the threshold value for defect detection is set to a high value. However, this degrades the sensitivity, and a defect having a difference value equal to or lower than the threshold value cannot be detected.

Further, the brightness difference due to film thickness difference may occur only between particular chips in arrayed chips in a wafer or may occur only in a particular pattern in a chip. When the threshold value is set in correspondence with these local areas, the entire inspection sensitivity is seriously lowered. Further, it is undesirable for a user to set the threshold value in correspondence with brightness difference by local area since the operation becomes complicated.

Further, the factor of the impairment of sensitivity is brightness difference between chips due to variation of pattern thickness. In the conventional comparative inspection by brightness, this brightness variation becomes noise during inspection.

On the other hand, there are various types of defects, and the defects are briefly classified into defects which should not be necessarily detected (regarded as normal pattern noise) and defects which should be detected. In the present application, a defect which is not a defect but has been erroneously detected as a defect (false report), normal pattern noise and the like will be referred to as a non-defect. In visual examination, it is necessary to extract only a defect desired by a user from a large number of defects. However, it is difficult to realize such extraction by the above-described comparison between luminance difference and the threshold value. Further, by combining factors depending on an object to be inspected such as material quality, surface roughness, size and depth, and factors depending on a detection system such as a illumination condition, the view of a defect often differs by type, and it is difficult to perform condition setting to extract only a desired defect.

The purpose of the present invention is to provide a defect inspecting apparatus and a defect inspecting method, by which a defect which a user desires to detect but is hidden in noise or in a defect unnecessarily detected can be detected with high sensitivity and high speed without requiring complicated threshold setting.

### Means for Solving Problem

To attain the above-described purpose, the present invention provides a defect inspecting apparatus including: an illumination optical system to illuminate an object to be inspected on a predetermined optical condition; and a detection optical system to detect scattered light from the object to be inspected, illuminated on a predetermined optical condition by the illumination optical system, on a predetermined detection condition, to obtain image data; and further, an image processing section having a feature calculating section to calculate the feature from inputted design data of an object to be inspected, a defect candidate detecting section to detect a defect candidate using image data in a corresponding position on the object to be inspected obtained by the detection optical system and the feature calculated by the feature calculating section, and a defect extracting section to extract a highly critical defect based on the feature of the design data calculated by the feature calculating section from the defect candidates detected by the defect candidate detecting section.

Further, in the present invention, the image data used in the defect candidate detecting section is a plurality of image data pieces on different optical conditions obtained by the detection optical system or different image data acquisition conditions. Further, in the present invention, in the defect candidate detecting section, a plurality of different defect candidate detection processes are performed in parallel in correspondence with a shape of a pattern formed on the object to be inspected. Further, in the present invention, in the defect candidate detecting section, any one of the plurality of detect candidate detection processes is applied with respect to each area of image data obtained by the detection optical system in correspondence with the shape of the pattern formed on the object to be inspected extracted from the design data of the object to be inspected.

Further, the present invention provides a defect inspecting apparatus including: an illumination optical system to illuminate an object to be inspected on a predetermined optical condition; and a detection optical system to detect scattered light from the object to be inspected, illuminated on a predetermined optical condition by the illumination optical system, on a predetermined detection condition, to obtain image data; and further, an image processing section having: a feature calculating section to calculate a feature from inputted design data of an object to be inspected and calculate a feature quantity from a plurality of image data pieces obtained on different optical conditions obtained by the detection optical system or different image data acquisition conditions, a defect candidate detecting section to perform integration processing between the feature from the design data calculated by the feature calculating section and feature quantities from the plurality of image data pieces to detect a defect candidate, and a defect extracting section to extract a highly critical defect based on the feature of the design data calculated by the feature calculating section from the defect candidates detected by the defect candidate detecting section.

Further, in the present invention, in the defect candidate detecting section the integration processing between the feature from the design data and the feature quantities from the plurality of image data is performed by determining a corresponding point from the design data.

Further, the present invention provides a defect inspecting apparatus including: an illumination optical system to illuminate an object to be inspected on a predetermined optical condition; and a detection optical system to detect scattered light from the object to be inspected, illuminated on a predetermined optical condition by the illumination optical system, on a predetermined detection condition, to obtain image data; and further, an image processing section having: a feature calculating section to calculate a feature from inputted design data of an object to be inspected and calculate a feature quantity from a plurality of image data pieces obtained on different optical conditions obtained by the detection optical system or different image data acquisition conditions, a defect candidate detecting section to perform integration processing between the feature from the design data in a corresponding position on the object to be inspected calculated by the feature calculating section and feature quantities from the plurality of image data pieces to detect a defect candidate, and a defect extracting section to extract a highly critical defect based on the feature of the design data calculated by the feature calculating section from the defect candidates detected by the defect candidate detecting section.

Further, in the present invention, the defect inspecting apparatus further including: a simulator to calculate image data obtained by irradiating the object to be inspected on a predetermined optical condition and detecting scattered light from the object to be inspected on a predetermined detection condition by simulation. The defect candidate detecting section establishes correspondence in the integration processing between the feature from the design data and the feature quantity from the plurality of image data based on the result of simulation by the simulator. Further, in the present invention, the simulator uses the design data in the simulation of the image data obtained from the object to be inspected.

### Effect of the Invention

According to the present invention, it is possible to detect a critical defect with a high sensitivity without complicated setting by utilizing design data.

### BRIEF DESCRIPTION OF DRAWINGS

FIG. 1 is a conceptual diagram showing a configuration of a defect inspecting apparatus according to the present invention;

FIG. 2 is a schematic block diagram showing an embodiment of the defect inspecting apparatus according to the present invention;

FIG. 3 is an explanatory diagram of a method of distribution of plural images detected on different optical conditions and design data according to the present invention;

FIG. 4 is a diagram showing an embodiment of defect candidate detection processing and defect extraction processing (critical defect extraction processing) by integration processing between the plural images detected on different optical conditions and design data, according to the present invention performed by an image processing section;

FIG. 5 is a diagram showing an embodiment of brightness shift correction processing between images in an image processing section (e.g. defect candidate detecting section) according to the present invention;

FIG. 6 is an explanatory diagram of a threshold value plane and a deviated pixel (defect candidate) in feature space formation (integration processing) performed in the image processing section (e.g. defect candidate detecting section) according to the present invention;

FIG. 7 is a diagram showing an embodiment where the design data is converted to image features in correspondence with inspection information and integration-processed with images to defect candidates, in the image processing section (e.g. defect candidate detecting section) according to the present invention;

FIG. 8 is a diagram showing another embodiment where the design data is converted to image features in correspondence with inspection information and integrated with images to detect defect candidates, in the image processing section (e.g. defect candidate detecting section) according to the present invention;

FIG. 9 is a diagram showing an embodiment where the design data is converted to image features in correspondence with inspection information to determine the critical level of a defect candidate, in the image processing section (e.g. defect candidate detecting section) according to the present invention;

FIG. 10A is a diagram showing an embodiment where corresponding points in images obtained on different optical conditions from the design data in the image processing section (e.g. defect candidate detecting section) according to the present invention;

FIG. 10B is a diagram showing an embodiment which illustrates optical conditions and images obtained from the optical simulation under different optical conditions according to the present invention;

FIG. 11 is a diagram showing an embodiment where defect candidate detection processing is set differently by area from the design data, in the image processing section (e.g. defect candidate detecting section) according to the present invention;

FIG. 12 is a diagram showing an embodiment where the defect candidate detection processing is set differently by area in the image processing section (e.g. defect candidate detecting section) according to the present invention;

FIG. 13A is an explanatory diagram of a method of defect determination mode setting by area in the image processing section (e.g. defect candidate detecting section) by using a GUI according to the present invention;

FIG. 13B is an explanatory diagram of a method of defect determination mode setting by area in the image processing section (e.g. defect candidate detecting section) by using a design data according to the present invention; and

FIG. 14 is a diagram showing an embodiment where the design data is converted to image features in correspondence with inspection information to perform critical level determination of a defect candidate in the image processing section (e.g. defect candidate detecting section) according to the present invention.

### BEST MODE FOR CARRYING OUT THE INVENTION

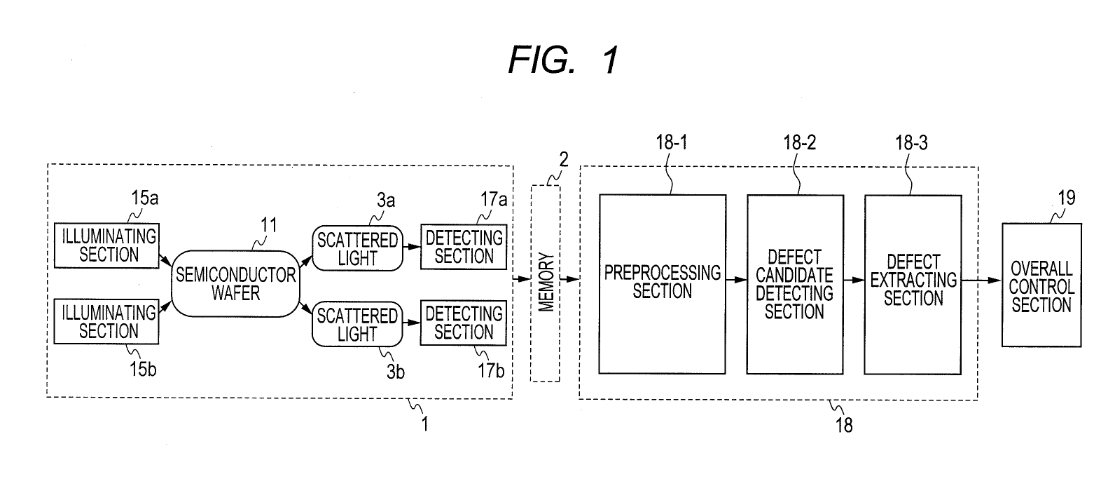

Embodiments of a defect inspecting apparatus and a method for the apparatus according to the present invention will be described using FIGS. 1 to 14. First, an embodiment of the defect inspecting apparatus by dark field illumination with respect to a semiconductor wafer as an object to be inspected will be described.

FIG. 1 is a conceptual diagram showing an embodiment of the defect inspecting apparatus according to the present invention. An optical section 1 has plural illuminating sections 15a and 15b and a detecting section 17. The illuminating section 15a and the illuminating section 15b emit illumination light on mutually different optical conditions (e.g., illuminating angles, polarizing status, wavelengths and the like are different) on the object to be inspected (semiconductor wafer 11). With the illumination light emitted from the respective illuminating section 15a and illuminating section 15b, scattered light 3a and scattered light 3b occur from the object to be inspected 11, and the scattered light 3a and the scattered light 3b are detected by the detecting section 17a and the detecting section 17b as scattered light intensity signals. The respective detected scattered light intensity signals are temporarily stored into a memory 2, then inputted into an image processing section 18. The image processing section 18 appropriately has a preprocessing section 18-1, a defect candidate detecting section 18-2 and a defect extracting section 18-3. The preprocessing section 18-1 performs signal correction, image division to be described later and the like on the scattered light intensity signals inputted in the image processing section 18. The defect candidate detecting section 18-2 performs processing to be described later on the images generated by the preprocessing section 18-1 to detect defect candidates. The defect extracting section 18-3 extracts defects of defect type(s) necessary for a user, a highly critical defect and the like except detects of defect types unnecessary for the user, uncritical defects and the like, from the defect candidates detected by the defect candidate detecting section 18-2, and outputs the extracted defects to an overall control section 19. In FIG. 1, an embodiment is shown where the scattered lights 3a and 3b are detected by the separate detecting sections 17a and 17b. However, it may be arranged such that the scattered lights are detected by one detecting section. Further, the number of the illuminating sections and detecting sections is not necessarily two but may be one or three or more.

The scattered light 3a and the scattered light 3b show scattered light distribution caused in correspondence with the respective illuminating sections 15a and 15b. When the optical condition of the illumination light by the illuminating section 15a and the optical condition of the illuminating section 15b are different, the scattered light 3a and the scattered light 3b caused by the respective illuminating sections are mutually different. In the present specification, the optical characteristic of scattered light caused by some illumination light and its feature will be referred to as scattered light distribution of the scattered light. More particularly, the scattered light distribution means distribution of optical parameter values such as intensity, amplitude, phase, polarization, wavelength, coherency and the like with respect to the emitted position, emitted direction and emitted angle of the scattered light.

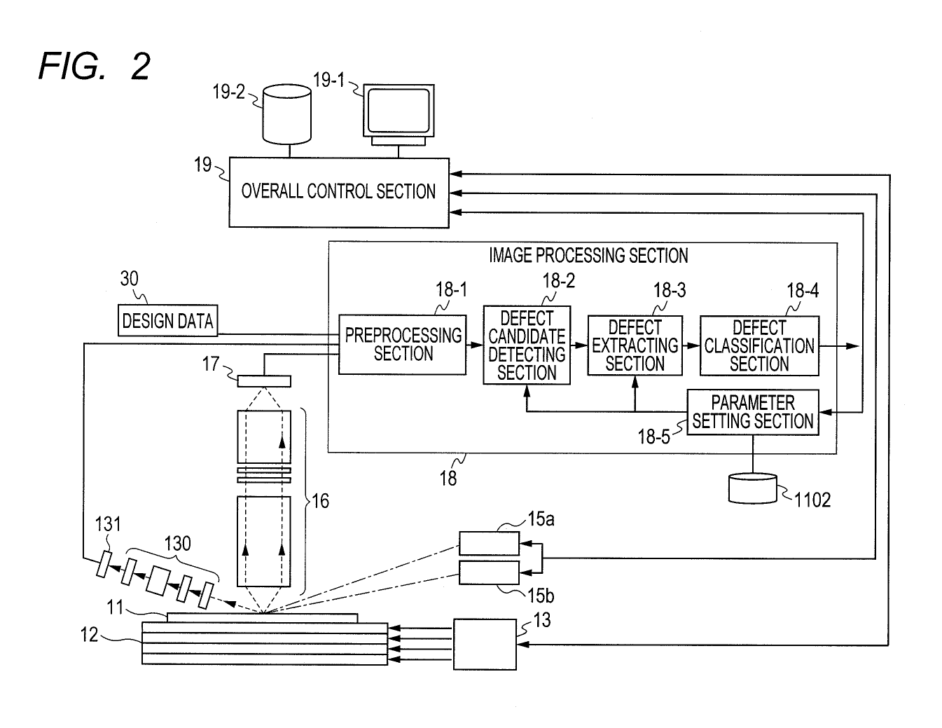

Next, FIG. 2 shows a schematic diagram as an embodiment of a particular defect inspecting apparatus realizing the configuration shown in FIG. 1. That is, the defect inspecting apparatus according to the present invention appropriately includes the plural illuminating sections 15a and 15b to emit illumination light from an oblique direction on an object to be inspected (semiconductor wafer 11), a detection optical system (upper detecting system) 16 to perform image forming of scattered light from the semiconductor wafer 11 in a vertical direction, a detection optical system (oblique detecting system) 130 to perform image forming of scattered light in the oblique direction, detecting sections 17 and 131 to receive optical images formed by the respective detection optical systems and convert the images into image signals, the memory 2 to store the obtained image signals, the image processing section 18, and the overall control section 19. The semiconductor wafer 11 is placed on a stage (X-Y-Z-θ stage) 12 which is movable and rotatable in an XY plane, and movable in a Z direction. The X-Y-Z-θ stage 12 is driven by a mechanical controller 13. The semiconductor wafer 11 is placed on the X-Y-Z-θ stage 12, and scattered light from a foreign material or a particle on the object to be inspected is detected while the X-Y-Z-θ stage 12 is moving in a horizontal direction, then the result of detection is obtained as a two-dimensional image.

As the respective illumination light sources of the illuminating sections 15a and 15b, laser or lamps may be used. Further, wavelengths of lights emitted from the respective illumination light sources may be a short wavelength or a broad-band wavelength light (white light). When using a light source which emits a short wavelength light, ultra violet light in an ultraviolet area (UV light) may be used to increase the resolution of a detected image (to detect a fine defect). When laser is used as a light source and it is single wavelength laser, it is possible to provide the illuminating sections 15a and 15b with a section to reduce coherency (not shown).

The optical path of the scattered light caused from the semiconductor wafer 11 is branched, and the one light is converted by the detecting section 17 via the detection optical system 16 into an image signal. Further, the other light is converted by the detecting section 131 via the detection optical system 130 into an image signal.

In the detecting sections 17 and 131, a time delay integration (TDI) image sensor in which plural one-dimensional image sensors are two-dimensionally arrayed is employed as an image sensor. In synchronization with movement of the X-Y-Z-θ stage 12, it is possible by the TDI image sensor to obtain a two-dimensional image at a comparatively high speed and with high sensitivity by transferring signals detected by the respective one-dimensional image sensors of the TDI image sensor to the one-dimensional image sensors of the second stage of the TDI image sensor and adding there. By using a parallel-output type TDI image sensor having plural output taps, the outputs from the detecting sections 17 and 131 can be processed in parallel, and it is possible to perform detection at a higher speed.

The image processing section 18 extracts a defect on the semiconductor wafer 11 by processing signals output from the detecting sections 17 and 131. The image processing section 18 includes a preprocessing section 18-1 to perform image correction such as shading correction and dark level correction on image signals inputted from the detecting sections 17 and 131 and divide the corrected images into images in a predetermined unit size, the defect candidate detecting section 18-2 to detect defect candidates from the corrected and divided image, the defect extracting section 18-3 to extract a critical defect other than user-designated unnecessary defects and noise from the detected defect candidates, a defect classification section 18-4 to classify the extracted critical defects in accordance with defect type, and a parameter setting section (teaching data setting section) 18-5 to receive an extraneously input parameter or the like and set it in the defect candidate detecting section 18-2 and the defect extracting section 18-3. In the image processing section 18, e.g. the parameter setting section 18-5 is connected to a data base 1102.

The overall control section 19, having a CPU (included in the overall control section 19) to perform various control, is connected to a user interface section (GUI section) 19-1 having a display section and an input section to receive a parameter from the user and the like and display a detected defect candidate image, an image of a finally-extracted defect and the like, and a storage device 19-2 to hold a feature quantity of the defect candidate detected by the image processing section 18, images and the like. The mechanical controller 13 drives the X-Y-Z-θ stage 12 based on a control command from the overall control section 19. Note that the image processing section 18, the detection optical systems 16 and 130 and the like are also driven based on the command from the overall control section 19.

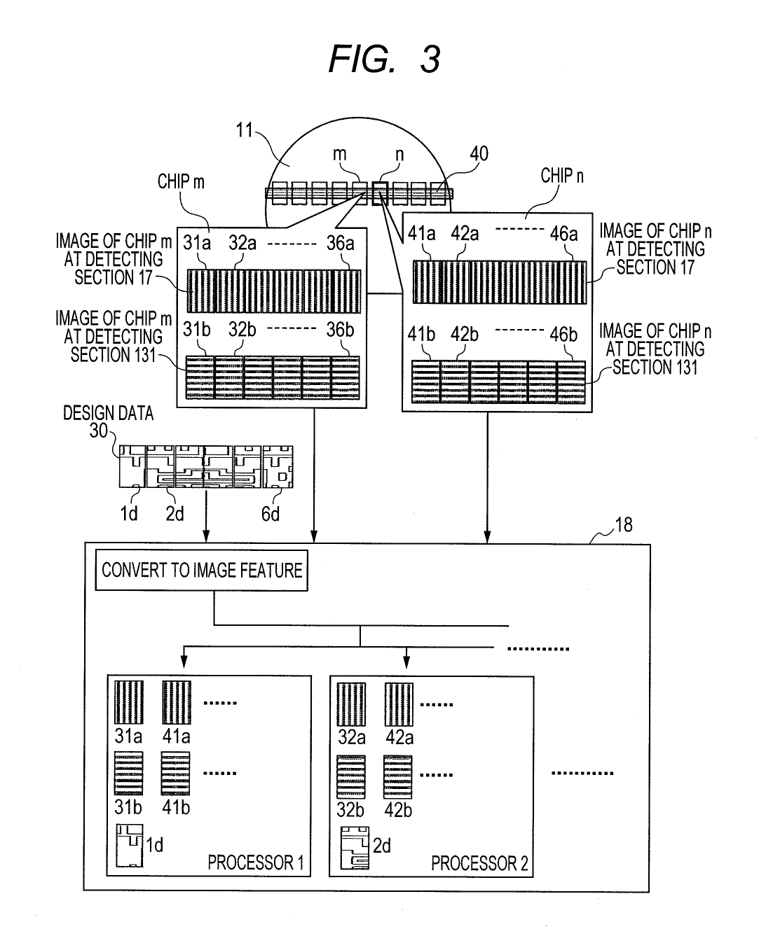

Note that in the present invention, in addition to the image signals as scattered light images from the semiconductor wafer 11, the design data 30 of the semiconductor wafer 11 is also inputted into the image processing section 18. Then, in the image processing section 18, in addition to the two image signals, the design data is integrated, to perform defect extraction processing. In the semiconductor wafer 11 as an object to be inspected, a large number of chips with the same pattern having a memory mat part and a peripheral circuit part are regularly arrayed. The overall control section 19 continuously moves the semiconductor wafer 11 with the X-Y-Z-θ stage 12, and in synchronization with this movement, sequentially inputs chip images from the detecting sections 171 and 131. Then, with respect to the obtained two types of scattered light images, the overall control section 19 compares images in the same position in the regularly arrayed chips with an image feature from the design data 30 in the corresponding position to extract defects. FIG. 3 shows the flow of the data. In the semiconductor wafer 11, for example, a band-shaped area 40 image is obtained by scanning of the X-Y-Z-θ stage 12.

Assuming that a chip n is an inspection object chip, numerals 41a, 42a, . . . , 46a denote divided images obtained by dividing an image of the chip n obtained from the detecting section 17 by 6. Further, numerals 31a, 32a, . . . , 36a denote divided images obtained by dividing an image of an adjacent chip m obtained from the detecting section 17 by 6 as in the case of the chip n. These divided images obtained from the same detecting section 17 are illustrated as vertical-striped images.

On the other hand, numerals 41b, 42b, . . . , 46b denote divided images similarly obtained by dividing a chip n image obtained from the detecting section 131 by 6. Further, numerals 41b, 42b, . . . , 46b denote divided images similarly obtained by dividing an image of an adjacent chip m obtained from the detecting section 131 by 6. These divided images obtained from the same detecting section 131 are illustrated as vertical-striped images. Further, numerals 1d, 2d, . . . , 6d denote data in positions corresponding to the 6 divided images with respect to the design data 30.

In the present invention, with respect to the images from the two detecting systems and design data inputted into the image processing section 18, division is performed such that all the data correspond on the chips. The defect inspecting apparatus according to the present invention converts the design data 30 to image features to be described later. The image processing section 18 has plural processors which operate in parallel. The respective corresponding images (e.g., the corresponding divided images 41a; 41b of the chip n obtained by the detecting sections 17 and 131, and the corresponding divided images 31a; 31b of the chip m) and the corresponding design data (1d) are inputted into the same processor 1, and the defect extraction processing is performed. On the other hand, in other corresponding positions, the divided images (42a; 42b) of the chip n obtained from the different detecting sections 17; 131 and the corresponding divided images (32a; 32b) of the adjacent chip m and the corresponding design data (2d) are inputted into the processor 2, and the defect extraction processing is performed in parallel to the processor 1.

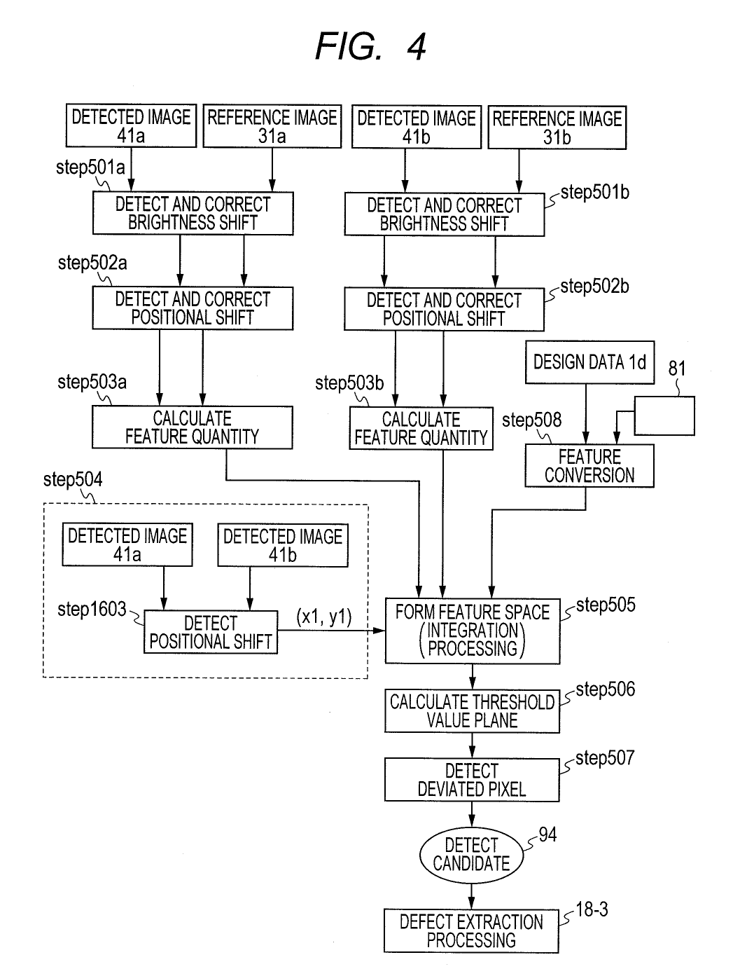

Next, the flow of processing in e.g. the defect candidate detecting section 18-2 of the image processing section 18 will be described in a case where the head divided images 41a; 41b of the chip n obtained by the two different detecting sections 17; 131, as shown in FIG. 3, are handled as inspection object images (hereinbelow, referred to as “detected images”), and the divided images 31a; 31b of corresponding areas of the adjacent chip m, as reference images. FIG. 4 shows the flow of processing in e.g. the defect candidate detecting section 18-2 and the defect extracting section 18-3 in the image processing section 18 to detect defect candidates by integration processing between the two types of image information (41a; 41b, 31a; 31b) obtained from the two different detecting sections 17;131 and the design data (1d), and perform the integration processing between the detected defect candidates (deviated pixels) and the image feature obtained from the design data to extract critical defects.

As described above, the defect candidate detecting processing and the defect extraction processing (critical defect extraction processing) are respectively performed by plural processors in parallel. The detected images (41a; 41b) in the same position obtained by the different detecting sections 17; 131, and the corresponding reference images (31a; 31b) and the design data (1d) as a set, are inputted into each processor, and the defect candidate detecting processing and the defect extraction processing (critical defect extraction processing) are performed.

In the semiconductor wafer 11, the same pattern is regularly formed as described above. Although the detected image 41a and the reference image 31a should be the same, there is a great difference of brightness between the images due to the difference of film thickness between the chips in the wafer 11 having a multi-layer film. Further, since an image acquisition position is shifted between the chips due to vibration in stage scanning or the like, in the image processing section 18, e.g. the preprocessing section 18-1 initially performs correction on the shift. First, the brightness shift between the detected image 41a and the reference image 31a obtained by the detecting section 17 is detected and corrected (step 501a). Next, the positional shift between the images is detected and corrected (step 502a). Similarly, the brightness shift between the detected image 41b and the reference image 31b obtained by the detecting section 130 is detected and corrected (step 501b). Next, the positional shift between the images is detected and corrected (step 502b).

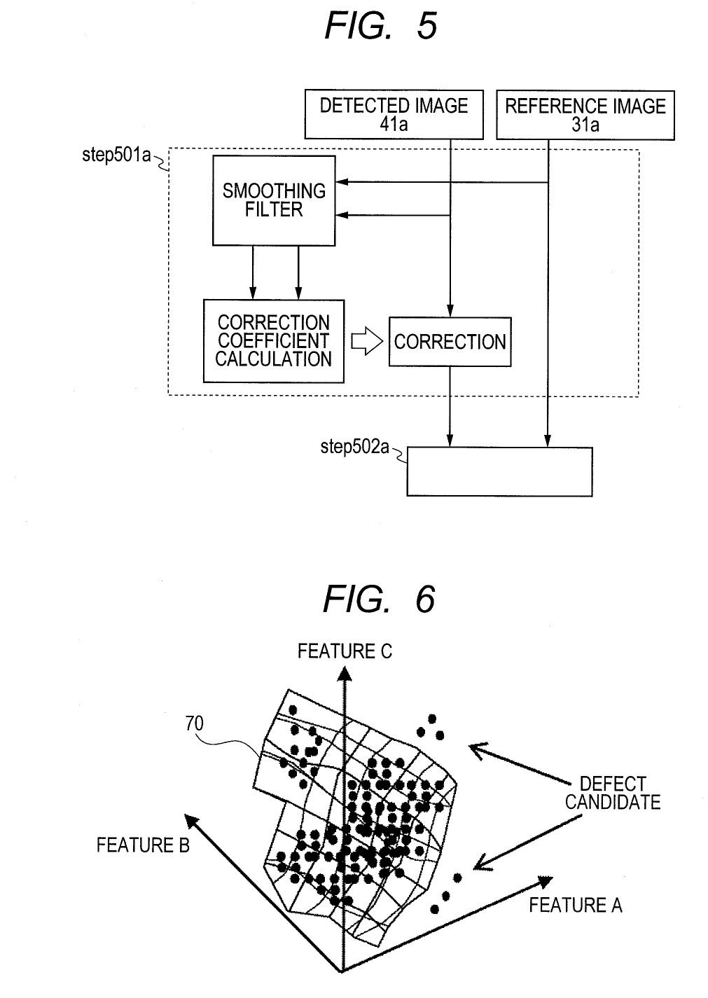

FIG. 5 shows a processing flow of the brightness shift detection performed by e.g. the defect candidate detecting section 18-2 in the image processing section 18 at the correction processing step 501a. A smoothing filter shown in expression (1) is applied to the input detected images 41a and 31a. The expression (1) shows an example of smoothing using a two-dimensional Gaussian functions, average 0 and variance σ², with respect to each pixel f(x, y) of the images 41a and 31a. Further, any of simple averaging shown in expression (2), a median filter to obtain a central value in a local area or the like may be used. Next, a correction coefficient to correct the brightness shift between the images is calculated. In this example, least squares approximation using all the pixels in the image is shown. In this example, assuming that a linear relation indicated with expression (3) exists regarding respective points Gf(x, y) and Gg(x, y) of the smoothed images 41a′ and 31a′, values a and b are calculated such that a minimum value is obtained with expression (4), and the calculated values are used as correction coefficients “gain” and “offset”. Then brightness correction as indicated in expression (5) is performed on all the pixels of a detected image f(x, y) prior to the smoothing.

$$\begin{matrix} [ Expression 1 ] & \\ G ( x , y ) = ( 1 / 2 {πσ}^{2} ) \cdot exp ( - ( {x}^{2} + {y}^{2} ) / 2 {σ}^{2} ) \\ G ( f ( x , y ) = G ( x , y ) * f ( x , y ) \\ * \text{:} convolution & ( 1 ) \\ [ Expression 2 ] & \\ G ( f ( x , y ) ) = \frac{1}{m \cdot n} {\sum }_{k = 1}^{m} {\sum }_{I = 1}^{n} f ( x - [ ( m - 1 ) / 2 ] + k - 1 , y - [ ( n - 1 ) / 2 ] + I - 1 ) \\ m , m \text{:} smoothed matrix size [ ] : Gaussian & ( 2 ) \\ G ( g ( x , y ) ) = a + b \cdot G ( f ( x , y ) ) & ( 3 ) \\ \sum {\{ G ( g ( x , y ) ) - ( a + b \cdot G ( f ( x , y ) ) ) \}}^{2} & ( 4 ) \\ L ( f ( x , y ) ) = gain \cdot f ( x , y ) + offset & ( 5 )\end{matrix}$$

Generally, the positional shift amount detection and correction process (step 502a and step 502b) shown in FIG. 4, is executed by calculating a shift amount to minimize the sum of squares of brightness difference between one image and the other image by shifting one of the two images or a shift amount to maximize a normalized correlation coefficient.

Next, with respect to the object pixel of the detected image 41a subjected to the brightness correction and positional correction, a feature quantity is calculated between the object pixels of the reference image 31a (step 503a). Similarly, a feature quantity is calculated between the detected image 41b and the reference image 31b (step 503b). Further, when the images obtained by the detecting sections 17 and 131 have been sequentially obtained, the positional shift amount between the detected image 41a and the detected image 41b is similarly calculated (step 504). Then, in view of the positional relation between the images obtained by the detecting sections 17 and 131, all or some of the feature quantities of the object pixel are selected, and feature space is formed (step 505). Any amount may be used as the feature quantity as long as it indicates the feature of the pixel. As an example, (1) contrast, (2) shade difference, (3) brightness dispersion value of neighbor pixel, (4) correlation coefficient, (5) brightness increase/decrease with respect to the neighbor pixel, and (6) second-derivative value and the like can be given. As an example of these feature quantities, assuming that the brightness of each point of a detected image is f(x, y) and the brightness of a corresponding reference image is g(x, y), the feature quantity is calculated from a set of images (41a and 31a, and 41b and 31b) with the following expression.

contrast: max{f(x,y), f(x+1,y), f(x,y+1), f(x+1,y+1)}−min{f(x,y), f(x+1,y), f(x,y+1), f(x+1,y+1)} (6)

shade difference: f(x,y)−g(x,y) (7)

fraction: [Σ{f(x+i,y+j)²}−{Σf(x+i,y+j)}²/M]/(M−1) i,j=−1,0,1 M=9 (8)

In addition, the brightness itself of each image (detected image 41a, reference image 31a, detected image 41b and reference image 31b) is used as a feature quantity. Further, it may be arranged such that the integration processing is performed on the images in the respective detecting systems and feature quantities (1) to (6) are obtained from an average value of e.g. the detected image 41a and the detected image 41b, the reference image 31a and the reference image 31b. Hereinbelow, an embodiment will be described in which brightness average Ba calculated with respect to the detected image 41a and the reference image 31a and brightness average Bb calculated with respect to the detected image 31b and the reference image 31b are selected as a feature quantity. When the positional shift of the detected image 41b with respect to the detected image 41a is (x1, y1), the feature quantity calculated from the output from the detecting section 131 with respect to the feature quantity Ba(x, y) of each pixel (x, y), calculated from the output from the detecting section 17, is Bb(x+x1, y+y1). Accordingly, the feature space is generated by plotting all the pixel values in two-dimensional space with the X value as Ba(x, y) and the Y value as Bb(x+x1, y+y1). Then, in the two-dimensional space, a threshold value plane is calculated (step 506), and a pixel outside the threshold value plane, i.e., a deviated pixel as a feature is detected as a defect candidate (step 507). Note that the feature space at step 505 is described as two-dimensional space. However, it may be multi-dimensional feature space with some or all the features as axes.

Further, in the present invention, the design data 1d in an area corresponding to a detected image is also inputted into the same processor. The input design data 1d is first converted to an image feature (image feature quantity) so as to be handled equally to a feature quantity calculated from the above-described image (step 508 in FIG. 4). Then defect candidates can be detected from the feature space to which the feature quantity calculated from the design data is added.

FIG. 6 is an embodiment of the feature space formed with three feature quantities. The respective pixels of the object image are plotted in the feature space with feature quantities A, B and C as axes in correspondence with the values of features A, B and C, and a threshold value plane is set so as to surround a distribution estimated as normal distribution. In the figure, a polygonal plane 70 is a threshold value plane, and pixels surrounded with the polygonal plane 70 are normal pixels (including noise), and deviated pixels outside the threshold value plane are defect candidates. The estimation of a normal range may be made by individually setting a threshold value by the user, or by assuming that the feature distribution of the normal pixels is a normal distribution and discriminating from the probability that the object pixel is a non-defect pixel. In the latter method, assuming that d feature quantities of n normal pixels are x1, x2, xn, a discrimination function φ to detect a pixel with a feature quantity x as a defect candidate is given with expression (9) and expression (10).

$$\begin{matrix} [ Expression 3 ] & \\ probability density function of x \\ p ( x ) = \frac{1}{{( 2 π )}^{\frac{d}{2}} \sqrt{\vert \sum \vert}} epx \{ - \frac{1}{2} {( x - μ )}^{t} ) {\sum }^{- 1} ( x - μ ) \\ μ = \frac{1}{n} {\sum }_{i = 1}^{n} {x}_{i} \\ μ \text{:} mean of teaching pixels & ( 9 ) \\ [ Expression 4 ] & \\ \sum \text{:} covariance \\ \sum = {\sum }_{i = 1}^{n} ( {x}_{i} - μ ) {( {x}_{i} - μ )}^{t} \\ \begin{matrix}discrimination function φ ( x ) = \\ \end{matrix} \begin{matrix}1 ( if p ( x ) \geq th then non \text{-} defect ) \\ 0 ( if p ( x ) < th then defect )\end{matrix} & ( 10 )\end{matrix}$$

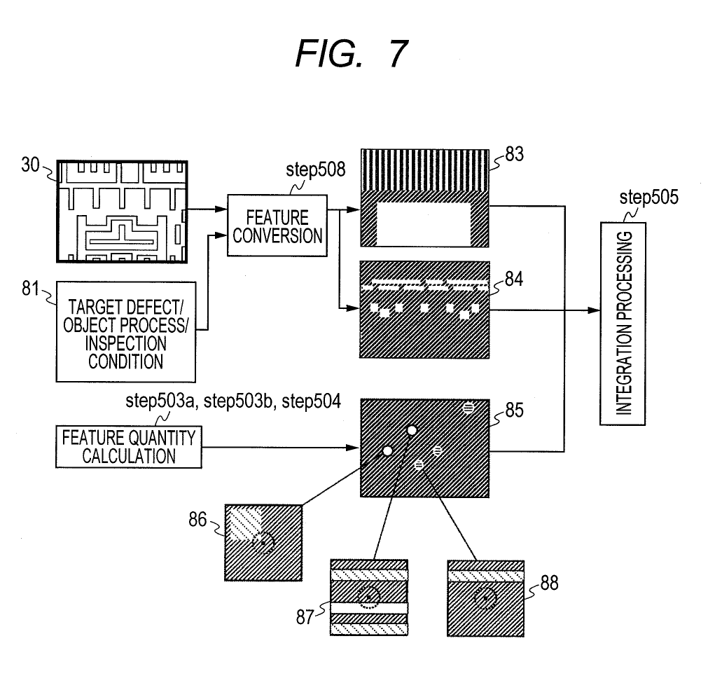

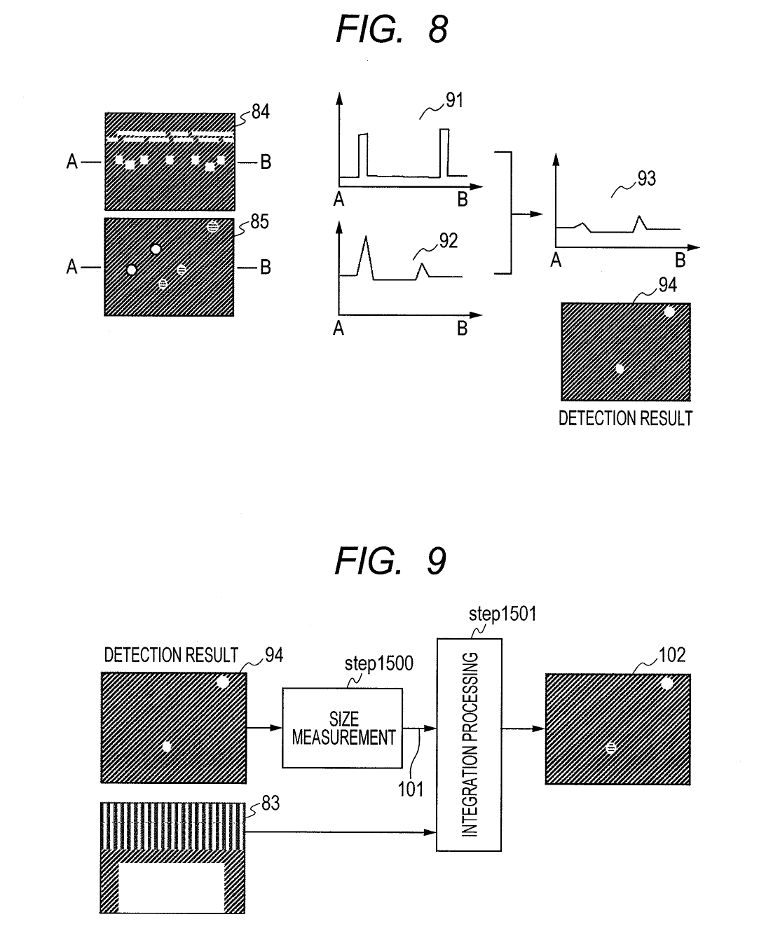

Next, an embodiment where the design data 1d is converted to an image feature (image feature quantity) at step 508 in FIG. 4 and an example of detecting defect candidate by using the converted image feature will be described using FIGS. 7 and 8. As indicated with numeral 30 in FIG. 7, the design data 1d inputted into the processor together with the above-described inspection object images 41a, 31a, 41b and 41b is binary (white or black) information indicating the wiring pattern structure or the like. In the present invention, together with the above-described binary design data 1d, inspection information 81 on the semiconductor wafer 11 as an object to be inspected such as a defect to be detected (target defect: e.g. short-circuit defect, foreign material or particle defect), subject process, inspection conditions (optical conditions such as illumination polarization status, illumination wavelength and polarization status during detection) is also inputted into the same processor, and further, in the design data 1d, feature conversion is performed in correspondence with the above-described inspection information 81 (step 508). The feature conversion (step 508) converts the above-described binary design data 30 (1d) into binary or multivalued data in the case of the image in correspondence with the above-described inspection information (target defect, subject process, inspection conditions (optical conditions such as illumination polarization status, illumination wavelength and polarization status upon detection)) 81.

In an example of the feature conversion 83 (conversion to multi-valued data), the binary design data 30 (1d) of the density or the line width of the wiring pattern which is variable in accordance with the subject process and obtained as the inspection information 81 is converted to a luminance value. Regarding an area where the wiring pattern is loose, the data is converted a low luminance (black) value, and an area where the wiring pattern is dense, the data is converted to a high luminance value (white). Since, the density or line width of the wiring pattern differs in accordance with subject process for the inspection object wafer, the feature conversion (step 508) reflecting the inspection conditions corresponding to the inspection information 81 is performed. That is, regarding an area where the wiring pattern is loose, since short circuit even with a comparatively large foreign material or particle is unlikely, a defect candidate is detected with a lowered sensitivity.

In another example of the feature conversion 84 (conversion to multi-valued data), in the binary design data 30 (1d), the probability of occurrence of noise (luminescent spot) which occurs as scattered light from a pattern corner, the edge of a thick wiring pattern or the like is converted to a luminance value in correspondence with the optical conditions (illumination conditions) included in the inspection information 81. In a part where the noise occurrence probability is high, luminance value is converted to high (white). Note that a pattern corner or edge of a thick wiring pattern is sometimes a point where the probability of occurrence of noise indicating a luminescent spot (high luminance) is high in accordance with optical condition (illumination condition) even if it is not a defect.

In this manner, the defect candidate detecting section 18-2 performs the integration processing between the image features 83 and 84 obtained by converting the design data 30 (1d) into multivalued data in correspondence with the inspection information 81, and image features 85 obtained by the detecting sections 17 and 131, to perform the defect candidate detection processing (step 505). Numeral 85 denotes an embodiment of a feature quantity calculated through the feature quantity calculation processing (step 503a, step 503b and step 504) from the input images 41a, 31a, 41b and 31b shown in FIG. 4, which is a defect candidate indicating the difference between the detected image and the reference image. In a bright part, the difference is large, and the possibility of defect is high. Numerals 86, 87 and 88 denote inspection images obtained by cutting neighboring parts of the defect candidate 85. A defect exists in a broken-line circle. Regarding the defect candidates in the images 86 and 87, though the difference is larger in comparison with the defect candidate in the image 88, it occurs at a pattern corner or a high-luminosity wiring pattern edge, and the possibility of noise is high. In this case, it may be difficult to eliminate noise from only feature quantities (85 in the figure) calculated from the image and set a threshold value to detect a defect with a small difference. On the other hand, in the present invention, it is possible to detect only a defect by performing the integration processing (step 505) using the image features (83, 84) converted from the feature (85) calculated from the images (41a, 41b, 31a and 31b) and the design data (38(1d)), and even if the difference is large, by lowering the sensitivity in a part with high probability of noise occurrence.

FIG. 8 shows an embodiment of processing to set a threshold value plane (step 506) by the integration processing between the image feature 84 obtained by conversion from the above-described design data 1d to multivalued data in correspondence with inspection information 81 and the feature 85 calculated from the image, and detect a deviated pixel outside the set threshold value plane (step 507). In the figure, numeral 91 denotes a value on line A-B in the image feature indicating the noise occurrence probability in the feature 84. Numeral 92 denotes a value on the line A-B in the feature quantity (here a difference with respect to the reference image) calculated from the image of the feature 85. Numeral 93 denotes a value on the line A-B in a defect probability distribution calculated by integration processing of these features. That is, even when the feature quantity (difference) denoted by numeral 92 is large, a part in which the noise occurrence probability 91 is high is subjected to the integration processing and the defect probability distribution 93 is small. In a part in which there is no noise occurrence probability 91, the feature quantity (difference) is actualized without any change as the defect probability distribution 93. Accordingly, a deviated pixel (white pixel in the figure) 94 is detected as a defect candidate by comparing the defect probability distribution 93 calculated through the integration processing with a threshold value. That is, in the feature 85 calculated from the images 41a, 41b, 31a and 31b, the pixel 94, in which the feature quantity (difference) is small but the noise occurrence probability obtained based on the image feature (84) converted from the design data (30(1d)) to multivalued data in correspondence with the inspection information 81 is low, is detected as a defect candidate.

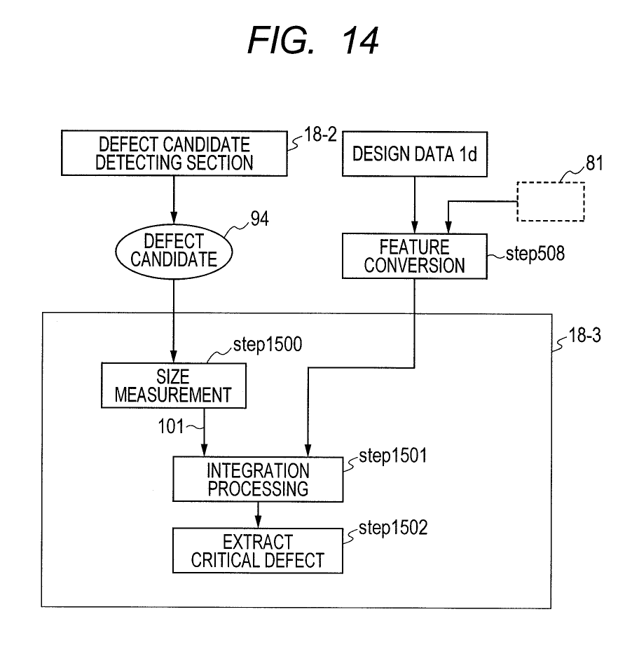

Next, processing in the defect extracting section 18-3 to extract only a defect necessary for the user from the defect candidate 94 detected by the defect candidate detecting section 18-2 will be described using FIG. 9 and FIG. 14. When the image feature converted from the design data 1d in correspondence with the inspection information 81 is inputted together with the defect candidates 94 detected by the defect candidate extracting section 18-2, the defect extracting section 18-3 first estimates the sizes of the respective defect candidates 94 (step 1500). Then, the defect extracting section 18-3 performs the integration processing between the respective estimated sizes 101 of the defect candidates 94 and the image feature (step 1501), calculates the critical levels of the respective defect candidates, and extracts only a critical defect (step 1502).

FIG. 9 shows a particular example of integration processing between the deviated pixels (defect candidates) 94 detected in FIG. 8 and the image feature 83 calculated from the design data 30 and extract a critical defect. Regarding the defect candidates 94 indicated with a white dot, the sizes of the defects (the area is calculated by counting the number of pixels in the defect, and the X-directional and Y-directional lengths are calculated by counting the number of pixels in the X direction and the Y direction of the defect) are estimated respectively from the detected image (step 1500). Then the size information 101 and the image feature 83 indicating the density of the wiring pattern are integrated (step 1501). Then calculation is made as to whether or not each defect candidate is critical on the wafer. Numeral 102 denotes an example of critical level distribution in which the critical levels of the respective defect candidates are indicated with luminance values. The critical level is high regarding a highly bright spot.

As described above, in the present invention, the design data is converted to an image feature having multi-level value such as binary or higher-level value, then the image feature and the feature calculated from the image are integrated at the respective stages of defect determination processing (the defect candidate detecting section, the defect extracting section and the like). By this processing, it is possible to discriminate noise from defects and to detect a highly critical defect immersed in noise and unnecessary defects by performing defect critical level estimation.

Further, in the present invention, in integration of images obtained on different optical conditions (step 505) shown in FIG. 4, the design data can be used. For example, upon integration between the detected images 41a and 41b obtained from the two detecting sections 17 and 131 in FIG. 2, it is desirable that the correspondence between the images is established, i.e., pixel positions in the images corresponds with each other with respect to the object. However, in a case where these images have been sequentially obtained, the acquisition positions with respect to the object do not always correspond with each other. Accordingly, it is necessary to calculate the positional shift between the images 41a and 41b and obtain the correspondence (step 504 in FIG. 4). Note that regarding images obtained with different detecting systems or on different optical conditions with respect to the same pattern, the view often differs due to a difference in shining of the pattern due to the difference of illuminating angle, a difference of obtained scattered light due to a difference of detection condition and the like, and the positional shift amount cannot be calculated without difficulty.

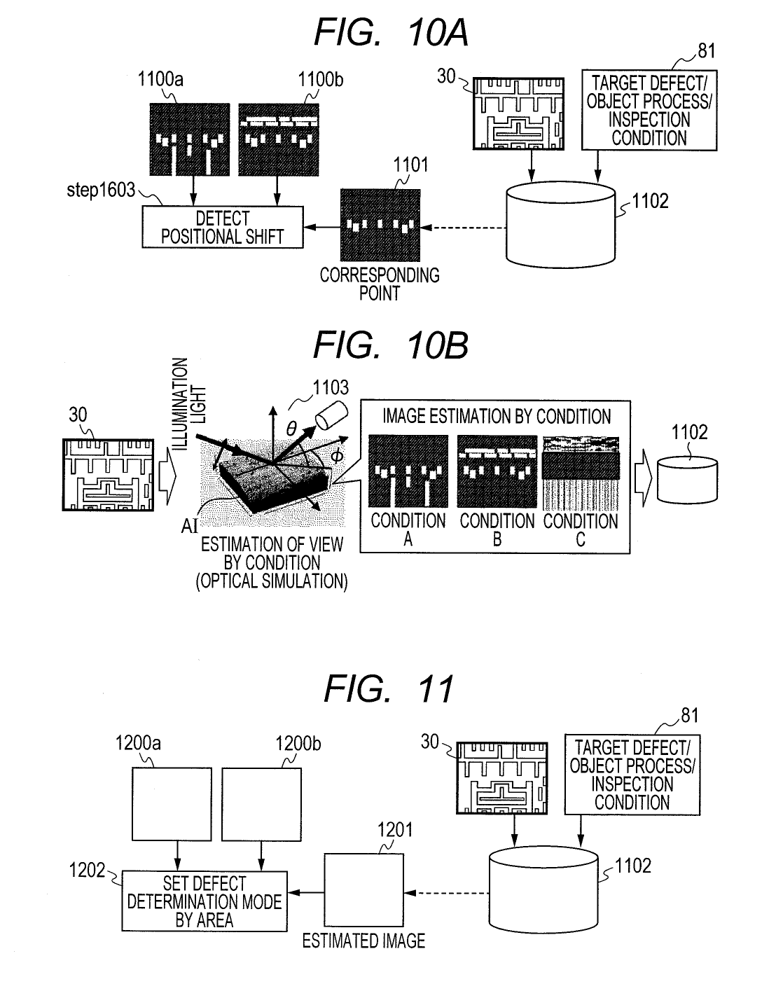

Accordingly, in the present invention, e.g. the image processing section 18 determines corresponding points in images with different views using the design data 30. FIG. 10A shows the flow of positional shift detection processing utilizing the design data 30 on an image which is detected by different detecting systems or obtained on different optical conditions. Numerals 1100a and 1100b shows example of images obtained from the different detecting sections 17 and 131 with respect to the same area of the same chip. Since the views of these two images are greatly different due to the difference of detecting section, it is difficult at step 1603 to calculate the positional shift amount between the images.

Accordingly, in the present invention, when the design data 30 in the corresponding area and the inspection information 81 on the semiconductor wafer as an object to be inspected such as subject process and inspection conditions are inputted, the image processing section 18, e.g., estimates images on the respective inspection conditions (here two inspection conditions) from the design data, and calculates corresponding points i.e. spots where the scattered light is obtained in common between the conditions (1101 in FIG. 10A). Then at step 1603, a positional shift amount of the point 1101, which is common in the two images 1100a and 1100b, to overlap with each other between the two images is calculated.

In this embodiment, the corresponding points between the images are registered in a database 1102. When the design data 30 and the inspection condition 81 are inputted, corresponding points corresponding to the data and condition are retrieved from the database 1102. As shown in FIG. 10B, the database 1102 is generated by estimating the views of the object wafer as inspection information by subject process and inspection conditions (illumination condition (dark field illumination), detection conditions (detection elevation angle θ and detection azimuth angle φ) etc.) with respect to the design data 30 by optical simulation (1103) and registering the estimated views. In this manner, the corresponding points may be obtained from the previously-registered database 1102. But, it may also be possible to calculate the corresponding points by the image processing section 18 when the design data 30 is inputted at inspection.

FIG. 11 shows another embodiment of utilization of the design data by e.g. the image processing section 18. Numeral 1200a denotes an image as an object to be inspected (detected image), and 1200b denotes a corresponding reference image. In the present invention, when the design data 30 of the semiconductor wafer, which is an inspection object, such as a position information of the corresponding points between the images 1200a and 1200b, a subject process, and inspection conditions are inputted, e.g. the image processing section 18 estimates images on the inspection conditions from the design data, and automatically sets an optimum defect determination mode with regard to the input image by area (1202). In the present invention, e.g. the image processing section 18 has plural defect determination modes. The image processing section 18 performs roughly dividing the region of the estimated image based on whether or not the pattern shines, whether the area has periodicity or it is a random area without periodicity. And performs defect determination processing with respect to the detected image in accordance with the predetermined defect determination mode which is set by the divided region. By this processing, high-sensitivity inspection is realized.

In this embodiment, the estimated image 1201 is previously registered in the database 1102. When the design data 30 and the inspection condition 81 are inputted, the estimated image corresponding to the data is retrieved from the database 1102. As shown in FIG. 10B, the database 1102 is generated by estimating a view of the object wafer by process and inspection condition (illumination condition, detection condition or the like) by optical simulation (an optical simulator is connected to the image processing section 18 or the overall control section 19) with respect to the design data 30 (1103) and registering the estimated views. In this manner, the image processing section 18 may obtain an estimated image from the previously registered database 1102. But, it may also be possible to calculate the estimated image when the design data is inputted at inspection. Further, the defect determination mode setting 1202 by area in the image processing section 18 may be performed using only the estimated image. However, it may be arranged such that the estimated image is integrated with an actual detected image.

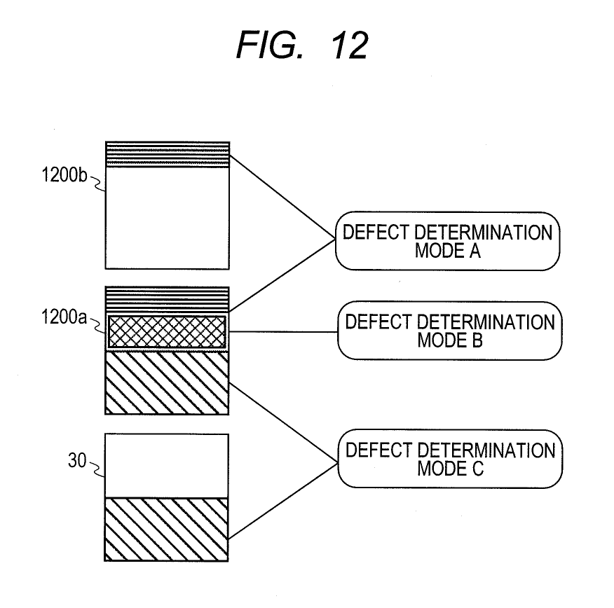

FIG. 12 shows an embodiment of the defect determination mode processed by area which is performed by e.g. the image processing section 18. Regarding the detected image 1200a, when it is estimated that a horizontal-striped area is a random pattern without periodicity, a defect determination mode A is set for the area. In the defect determination mode A, the brightness of the detected image 1200a is compared with that of e.g. the reference image 1200b, and a pixel having a great difference is determined as a defect candidate. Further, regarding a blank area, when it is determined that there is no pattern, i.e., the area is a flat brightness area without occurrence of scattered light, a defect determination mode B is set for the area. In the defect determination mode B, the detected image 1200a is compared with e.g. a threshold value, and a pixel brighter than the threshold value is determined as a defect candidate. Further, when it is determined that a hatched area is a pattern area with fine periodicity, a defect determination mode C is set for the area. In the defect determination mode C, the detected image 1200a is compared with e.g. the design data, and a pixel with a periodic pattern pitch and line width greatly different from the design values is determined as a defect candidate. In this manner, a defect is detected with high sensitivity by performing optimum defect determination processing by area, such as comparison with a reference image, comparison with a threshold value and comparison with design data. Further, it is unnecessary for the user to perform complicated area setting and mode setting by area by the area estimation from the design data and automatic defect determination mode setting corresponding to the feature of the area.

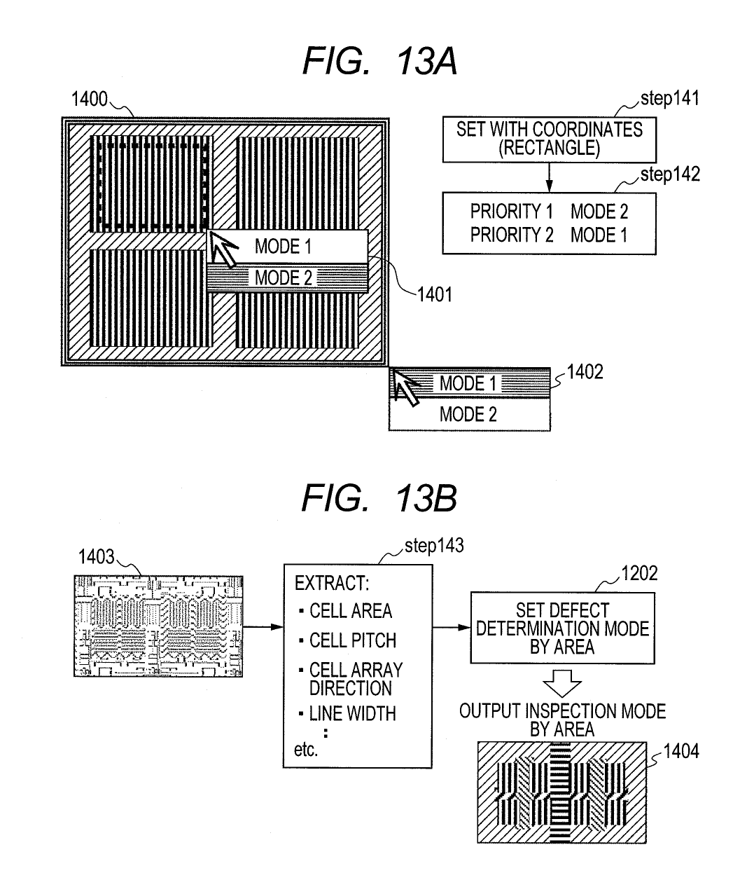

FIG. 13A shows a normal setting method when plural defect determination modes using a GUI section 19-1 are set by area. In the figure, numeral 1400 denotes an inputted chip image. The user sets a rectangular area on the image displayed on the GUI (step 141), and sets a defect determination mode by the designated rectangular area. In this example, a mode 2 is set for an area surrounded with a broken line denoted by numeral 1400 (1401), and a mode 1 is set for an area surrounded with a double line (1402). Since the mode 1 and the mode 2 are set for the area surrounded with the broken line, priority is set with respect to areas for which different modes are set (step 142). In the area surrounded with the broken line, the defect determination mode 2 with high priority is set. FIG. 13B shows an example of the defect determination mode automatically set by area with e.g. the image processing section 18 utilizing the design data shown in FIG. 12. When chip design data 1403 is inputted, in the present invention, e.g. the image processing section 18 extracts structural information such as information as to cell area (memory mat part formed by repeating the same fine pattern) or peripheral circuit part, cell pitch of the cell area (repetitive pattern period), cell array direction (X direction in the image or Y direction), line width and the like from the design data 30 (step 143). Then, the image processing section performs area division in correspondence with the extracted structural information, and sets an optimum defect determination mode by the divided area (1202). Numeral 1404 shows the defect determination modes for the respective divided areas based on the design data 30 with black, vertical stripes, horizontal stripes and diagonal lines. These plural defect determination processes can be performed in parallel or in a time-sequential manner.

As described above, according to the defect inspecting apparatus according to the present invention, the plural images 41a; 41b and 31a; 31b with different views in accordance with plural detecting systems, plural optical conditions and the like and the corresponding design data 1b are inputted into the image processing section 18. The image processing section 18 extracts plural features corresponding to the inspection information 81 from the design data 1b, and obtains multivalued image features. Then the image processing section 18 enables high-sensitive detection of defect candidates 94 using the feature quantity 85 calculated from the images 41a; 41b and 31a; 31b and the multivalued image features 83 and 84 extracted from the design data 1b. Further, the image processing section 18 performs critical level determination to the above-described detected defect candidates 94 by using the design data 1b (83), and mark out the highly critical defects from the large number of non-critical defects. Further, the image processing section 18 performs positioning of corresponding points in positional shift detection among the plural images with different views obtained from the design data, and performs integration processing on the feature quantities to detect the defect candidates 94. The detection of the defect candidates 94 is performed based on the optimum defect determination mode which differs by the area. Note that the high-sensitivity inspection is realized without complicated operations and setting by the user by obtaining pattern layout information in the chip from the design data and automatically setting an optimum mode in correspondence with the feature.

Even when there is a slight difference of pattern film thickness after flattening process such as CMP or great brightness difference between compared chips due to shortened wavelength of illumination light, detection of defect in size of 20 nm to 90 nm is realized by the present invention.

Further, at inspection of a low k film including inorganic insulating films such as an SiO₂ film, an SiOF film, a BSG film, a SiOB film and a porous silica film, and organic insulating films such as a methyl SiO₂ film, an MSQ film, a polyimide film, a parylene film, a Teflon (registered trademark) film, and an amorphous carbon film, even when there is a local brightness difference due to variation of refractive index distribution within the film, according to the embodiments of the present invention, a defect in size of 20 nm to 90 nm can be detected.

As described above, the examples of comparative inspecting images in a dark field inspecting apparatus in which a semiconductor wafer is handled as an object in the embodiments of the present invention have been explained. However, the present invention is also applicable to comparative images in an electron beam pattern inspection. Further, the present invention is also applicable to a bright field illumination pattern inspecting apparatus.

The object to be inspected is not limited to a semiconductor wafer, but the present invention is applicable to e.g. a TFT substrate, a photo mask, a print board or the like as long as it is subjected to the defect inspections by the image comparison.

### DESCRIPTION OF REFERENCE NUMERALS

2 . . . memory, 3a, 3b . . . scattered light, 11 . . . semiconductor wafer, 12 . . . X-Y-Z-θ stage, 13 . . . mechanical controller, 15a, 15b . . . illumination section, 16 . . . detection optical system, 17, 131 . . . detecting section, 18 . . . image processing section, 18-1 . . . preprocessing section, 18-2 . . . defect candidate detecting section, 18-3 . . . defect extracting section, 18-4 . . . defect classification section, 18-5 . . . parameter setting section (teaching data setting section), 19-1 . . . user interface section, 19-2 . . . storage device, 19 . . . overall control section, 30 . . . design data, 1d-6d . . . design data, 41a-46a and 41b-46b . . . detected image, 31a-36a and 31b-36b . . . reference image, 81 . . . inspection information, 83 and 84 . . . design data image feature, 85 . . . defect candidate indicated with a difference between detected image and reference image, 86, 87 and 88 . . . detected image including a defect candidate obtained by cutting the periphery of defect candidate 85, 94 . . . defect candidate, 101 . . . size information of each defect candidate, 102 . . . critical level distribution, and 1102 . . . database.

1. A defect inspecting apparatus comprising:
an illumination optical system to illuminate an object to be inspected on a predetermined optical condition;
a detection optical system to detect scattered light from the object to be inspected, illuminated on a predetermined optical condition by the illumination optical system, on a predetermined detection condition, to obtain image data;
an image processing section having a feature calculating section to calculate a feature from inputted design data of the object to be inspected;
a defect candidate detecting section to detect a defect candidate using image data in a corresponding position on the object to be inspected obtained by the detection optical system and the feature calculated by the feature calculating section; and
a defect extracting section to extract a highly critical defect based on the feature of the design data calculated by the feature calculating section from the defect candidates detected by the defect candidate detecting section.

2. The defect inspecting apparatus according to claim 1, wherein the image data used in the defect candidate detecting section is a plurality of image data pieces on different optical conditions obtained by the detection optical system or different image data acquisition conditions.

3. The defect inspecting apparatus according to claim 1, wherein in the defect candidate detecting section, a plurality of different defect candidate detection processes are performed in parallel in correspondence with a shape of a pattern formed on the object to be inspected.

4. The defect inspecting apparatus according to claim 1, wherein in the defect candidate detecting section, any one of the plurality of detect candidate detection processes is applied with respect to each area of image data obtained by the detection optical system in correspondence with the shape of the pattern formed on the object to be inspected which is extracted from the design data of the object to be inspected.

5. A defect inspecting apparatus comprising:
an illumination optical system to illuminate an object to be inspected on a predetermined optical condition;
a detection optical system to detect scattered light from the object to be inspected, illuminated on a predetermined optical condition by the illumination optical system, on a predetermined detection condition, to obtain image data; and
an image processing section having, a feature calculating section to calculate a feature from inputted design data of object to be inspected and calculate a feature quantity from a plurality of image data pieces obtained on different optical conditions obtained by the detection optical system or different image data acquisition conditions, a defect candidate detecting section to perform integration processing between the feature from the design data calculated by the feature calculating section and feature quantities from the plurality of image data pieces to detect a defect candidate, and a defect extracting section to extract a highly critical defect based on the feature of the design data calculated by the feature calculating section from the defect candidates detected by the defect candidate detecting section.

6. The defect inspecting apparatus according to claim 5, wherein in the defect candidate detecting section the integration processing between the feature from the design data and the feature quantities from the plurality of image data is performed by determining a corresponding point from the design data.

7. A defect inspecting apparatus comprising:
an illumination optical system to illuminate an object to be inspected on a predetermined optical condition;
a detection optical system to detect scattered light from the object to be inspected, illuminated on a predetermined optical condition by the illumination optical system, on a predetermined detection condition, to obtain image data; and
an image processing section having a feature calculating section to calculate a feature from inputted design data of the object to be inspected and calculate a feature quantity from a plurality of image data pieces obtained on different optical conditions obtained by the detection optical system or different image data acquisition conditions, a defect candidate detecting section to perform integration processing between the feature from the design data in a corresponding position on the object to be inspected calculated by the feature calculating section and feature quantities from the plurality of image data pieces to detect a defect candidate, and a defect extracting section to extract a highly critical defect based on the feature of the design data calculated by the feature calculating section from the defect candidates detected by the defect candidate detecting section.

8. The defect inspecting apparatus according to claim 7, further comprising: a simulator to calculate image data obtained by irradiating the object to be inspected on a predetermined optical condition and detecting scattered light from the object to be inspected on a predetermined detection condition by simulation,
wherein the defect candidate detecting section establishes correspondence in the integration processing between the feature from the design data and the feature quantity from the plurality of image data based on the result of simulation by the simulator.

9. The defect inspecting apparatus according to claim 8, wherein the simulator uses the design data in the simulation of the image data obtained from the object to be inspected.

10. A defect inspecting method using a defect inspecting apparatus which is having an illumination optical system to illuminate an object to be inspected on a predetermined optical condition; and a detection optical system to detect scattered light from the object to be inspected, illuminated on a predetermined optical condition by the illumination optical system, on a predetermined detection condition, to obtain image data, said method comprising the steps of:
an image processing process including a feature calculating step of calculating a feature from inputted design data of an object to be inspected,
a defect candidate detecting step of detecting a defect candidate using image data in a corresponding position on the object to be inspected obtained by the detection optical system and the feature calculated by the feature calculating section, and
a defect extracting step of extracting a highly critical defect based on the feature of the design data calculated at the feature calculating step from the defect candidates detected at the defect candidate detecting step.

11. A defect inspecting method using a defect inspecting apparatus which is having an illumination optical system to illuminate an object to be inspected on a predetermined optical condition; and a detection optical system to detect scattered light from the object to be inspected, illuminated on a predetermined optical condition by the illumination optical system, on a predetermined detection condition, to obtain image data, the method comprising the steps of:
a feature calculating step of calculating a feature from inputted design data of the object to be inspected and calculate a feature quantity from a plurality of image data pieces obtained on different optical conditions obtained by the detection optical system or different image data acquisition conditions;
a defect candidate detecting step of performing integration processing between the feature from the design data calculated at the feature calculating step and feature quantities from the plurality of image data pieces to detect a defect candidate; and
a defect extracting step of extracting a highly critical defect based on the feature of the design data calculated at the feature calculating step from the defect candidates detected at the defect candidate detecting step.

12. A defect inspecting method using a defect inspecting apparatus having: an illumination optical system to illuminate an object to be inspected on a predetermined optical condition; and a detection optical system to detect scattered light from the object to be inspected, illuminated on a predetermined optical condition by the illumination optical system, on a predetermined detection condition, to obtain image data, the method comprising the steps of:
a feature calculating step of calculating a feature from inputted design data of the object to be inspected and calculate a feature quantity from a plurality of image data pieces obtained on different optical conditions obtained by the detection optical system or different image data acquisition conditions;
a defect candidate detecting step of performing integration processing between the feature from the design data in a corresponding position on the object to be inspected calculated at the feature calculating step and feature quantities from the plurality of image data pieces to detect a defect candidate; and
a defect extracting step of extracting a highly critical defect based on the feature of the design data calculated at the feature calculating step from the defect candidates detected at the defect candidate detecting step.
